(19) United States
(12) Patent Application Publication
(10) Pub. No.: US 2025/0345936 A1
(43) Pub. Date: Nov. 13, 2025

(54) LIDAR SENSOR MOUNTED ON WALKING ROBOT AND METHOD FOR CONTROLLING THEREOF

(71) Applicant: HL KLEMOVE CORPORATION, Incheon (KR)

(72) Inventor: Daegyeong KIM, Incheon (KR)

(21) Appl. No.: 18/910,829

(22) Filed: Oct. 9, 2024

(30) Foreign Application Priority Data
May 8, 2024 (KR) 10-2024-0060508

(51) Int. Cl. B25J 9/16; G01S 7/481; G01S 17/89; G01S 17/931

(52) U.S. Cl. CPC B25J 9/1664; B25J 9/1607; G01S 7/4814; G01S 17/89; G01S 17/931

(57) ABSTRACT

The present disclosure relates to a lidar sensor mounted on a walking robot and a method for controlling thereof, and the lidar sensor mounted on a walking robot includes a memory containing at least one instruction; and at least one processor for executing the at least one instruction stored in the memory, wherein the processor is configured to apply current to an optical angle controller formed of a metamaterial to irradiate light according to a reflection angle of light changed by an amount of electrical stimulation, control an inertial measurement unit to measure an inertia value corresponding to a motion of the lidar sensor at the time of irradiating the light, and perform correction of the inertia value. The present disclosure can also be applied to other embodiments.

### CROSS-REFERENCE TO RELATED APPLICATION

This application claims priority to and the benefit of Korean Patent Application No. 10-2024-0060508, filed on May 8, 2024, the disclosure of which is incorporated herein by reference in its entirety.

### TECHNICAL FIELD

The present disclosure relates to a lidar sensor mounted on a walking robot and a method for controlling thereof.

### BACKGROUND

Autonomous driving robots perceive their surroundings, detect obstacles, and move autonomously using driving means such as wheels. Autonomous driving robots provide various services to users of space, such as guidance to specific locations through voice, screen, or accompaniment, and delivery of goods in public spaces such as train stations, bus terminals, and airports, as well as large spaces such as convention centers, shopping centers, hotels, and resorts. To do this, the autonomous driving robot checks for the presence of objects, etc., at the destination it wants to move to from its location.

These autonomous driving robots typically use cameras, radar sensors, lidar sensors, etc. to detect the presence of objects. Cameras and radar sensors have the advantage of recognizing the surrounding environment in a short period of time, but they have the problem of not being able to recognize the environment in dark spaces where objects cannot be identified with the naked eye.

Accordingly, the adoption of lidar sensors, which make it easy to identify objects regardless of the brightness of the surrounding environment, is increasing in autonomous driving robots. However, in the case of lidar sensors, there is a problem in that the accuracy of identifying objects using sensing data acquired when movement occurs in the lidar sensor decreases. Therefore, a technology is needed that can improve the accuracy of object identification included in sensing data acquired from a lidar sensor by compensating for the movement of the lidar sensor.

### BRIEF SUMMARY

### Technical Problem

Embodiments of the present disclosure to solve these conventional problems are directed to providing a lidar sensor mounted on a walking robot that may facilitate object identification by including a metamaterial capable of changing a reflection angle of light by electrical stimulation and an inertial measurement unit (IMU) capable of detecting the movement of the lidar sensor, and a method of controlling the same.

In addition, embodiments of the present disclosure are directed to providing a lidar sensor mounted on a walking robot capable of improving the accuracy of object identification included in sensing data obtained by the lidar sensor by correcting the movement of the lidar sensor, and a method of controlling the same.

### Technical Solution

A lidar sensor mounted on a walking robot according to an exemplary embodiment of the present disclosure includes a memory containing at least one instruction; and at least one processor for executing the at least one instruction stored in the memory, wherein the processor is configured to apply current to an optical angle controller formed of a metamaterial to irradiate light according to a reflection angle of light changed by an amount of electrical stimulation, control an inertial measurement unit to measure an inertia value corresponding to a motion of the lidar sensor at the time of irradiating the light, and perform correction of the inertia value.

In addition, the processor may be configured to check the existence of at least one object based on image data obtained from an image sensor that collects the irradiated light reflected and returned by the at least one object.

In addition, the processor may be configured to control the angle of a beam splitter included in the image sensor so that light irradiated from a light source unit can be reflected and irradiated by the optical angle controller.

In the processor may be configured to change the amount of electrical stimulation to selectively change the reflection angle periodically or upon conditional convergence.

In addition, the processor may be configured to map the reflection angle and the inertia value and store them in the memory.

In addition, the processor may be configured to correct the inertia value by applying a linear interpolation or quadratic interpolation method when a change in the motion is detected.

In addition, the processor may be configured to remove noise of the inertia value measured by the inertial measurement unit.

In addition, the processor may be configured to change the amount of electrical stimulation by confirming that the condition is converged if the at least one object identified in the image data exceeds the critical area of the image data.

Furthermore, a lidar sensor mounted on a walking robot according to another exemplary embodiment of the present disclosure includes a light source unit configured to irradiate light; an optical angle controller formed of a metamaterial to irradiate light according to a reflection angle of light that is changed by an amount of electrical stimulation; an inertial measurement unit configured to measure an inertia value corresponding to a motion of the lidar sensor at the time when the optical angle controller irradiates the light; and a processor configured to apply current corresponding to the amount of electrical stimulation to the optical angle controller and correct the inertia value.

In addition, the lidar sensor mounted on a walking robot may further include an image sensor including a beam splitter that adjusts an angle so that light irradiated from the light source unit can be reflected and irradiated by the optical angle controller, and configured to generate image data by collecting the irradiated light reflected and returned by at least one object.

In addition, the processor may be configured to change the amount of electrical stimulation periodically or upon conditional convergence so that the reflection angle is selectively changed.

In addition, the processor may be configured to map the reflection angle and the inertia value.

Furthermore, a method for controlling a lidar sensor mounted on a walking robot according to an exemplary embodiment of the present disclosure includes applying, by a processor, current to an optical angle controller formed of a metamaterial to irradiate light according to a reflection angle of light that is changed by an amount of electrical stimulation; checking, by the processor, an inertia value corresponding to a motion of the lidar sensor measured by an inertial measurement unit at the time when the optical angle controller irradiates the light; and correcting, by the processor, the inertia value.

In addition, the method may further include checking, by the processor, the existence of at least one object in image data obtained from an image sensor that collects the irradiated light reflected and returned by the at least one object.

In addition, after the applying current, the method may further include controlling, by the processor, the angle of a beam splitter included in the image sensor so that light irradiated from a light source unit can be reflected and irradiated by the optical angle controller; and controlling, by the processor, the light source unit to irradiate the light.

In addition, the method may further include changing, by the processor, the amount of electrical stimulation to selectively change the reflection angle periodically or upon conditional convergence.

In addition, after the checking an inertia value corresponding to a motion, the method may further include mapping, by the processor, the reflection angle and the confirmed inertia value.

In addition, the correcting may be a step of correcting the inertia value by applying a linear interpolation or quadratic interpolation method when a change in the motion is detected.

In addition, the correcting may include removing, by the processor, noise of the inertia value.

In addition, the changing the amount of electrical stimulation may be a step of changing the amount of electrical stimulation by confirming that the condition is converged if the at least one object identified in the image data exceeds the critical area of the image data.

### Advantageous Effects

As described above, the lidar sensor mounted on a walking robot and the method for controlling the same according to the present disclosure can easily perform object identification by providing a metamaterial that can change the reflection angle of light by electrical stimulation and the initial measurement unit (IMU) that can detect the movement of the walking robot.

In addition, the lidar sensor mounted on a walking robot and the method for controlling the same according the present disclosure can improve the accuracy of object identification included in sensing data obtained by the lidar sensor by correcting the movement of the lidar sensor.

### BRIEF DESCRIPTION OF THE SEVERAL VIEWS OF THE DRAWINGS

FIG. 1 is a diagram schematically showing the main configuration of a lidar sensor mounted on a walking robot according to an exemplary embodiment of the present disclosure.

FIG. 2 is a flowchart for describing a method for controlling a lidar sensor mounted on a walking robot according to an exemplary embodiment of the present disclosure.

FIG. 3 is a diagram for describing motion compensation of a lidar sensor according to an exemplary embodiment of the present disclosure.

### DETAILED DESCRIPTION

Hereinafter, preferred embodiments according to the present disclosure will be described in detail with reference to the accompanying drawings. The detailed description to be disclosed hereinafter with the accompanying drawings is intended to describe exemplary embodiments of the present disclosure and is not intended to represent the only embodiments in which the present disclosure may be implemented. In the drawings, parts unrelated to the description may be omitted for clarity of description of the present disclosure, and like reference numerals may designate like elements throughout the specification.

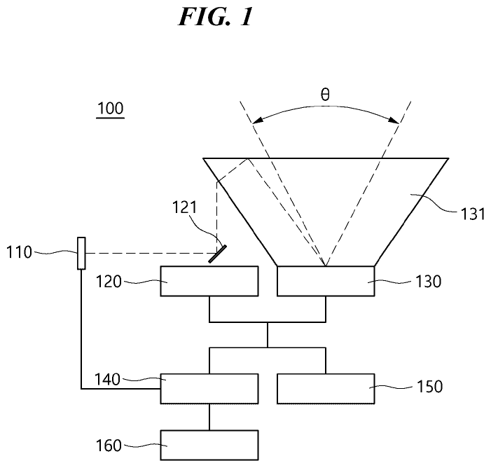

FIG. 1 is a diagram schematically showing the main configuration of a lidar sensor mounted on a walking robot according to an exemplary embodiment of the present disclosure.

Referring to FIG. 1, the lidar sensor 100 according to the present disclosure may include a light source unit 110, an image sensor 120, an optical angle controller 130, a processor 140, an inertial measurement unit 150, and a memory 160.

The light source unit 110 irradiates light under the control of the processor 140.

The image sensor 120 is implemented including a beam splitter 121, and the angle of the beam splitter 121 is controlled by the processor 140. The image sensor 120 generates image data based on light emitted from the light source unit 110 and reflected and returned by at least one object existing outside the lidar sensor 100.

The optical angle controller 130 is formed of a metamaterial, and the reflection angle θ of light is set by the current applied from the processor 140, i.e. the amount of electrical stimulation, and light is irradiated according to the set reflection angle. In this case, a prism 131 is implemented in the front of the optical angle controller 130, the light reflected by the beam splitter 121 is reflected by the prism 131 and irradiated to a part of the optical angle controller 130, and the light irradiated to the optical angle controller 130 is irradiated to the outside of the lidar sensor 100 in response to the reflection angle set by the amount of electrical stimulation corresponding to the current applied to the optical angle controller 130.

The processor 140 applies current to the optical angle controller 130 formed of a metamaterial. In this way, when the processor 140 applies current to the optical angle controller 130, the optical angle controller 130 may set the light reflection angle θ by the amount of electrical stimulation, and light may be irradiated according to the set light reflection angle.

The processor 140 controls the angle of the beam splitter 121 included in the image sensor 120. The processor 140 controls the light source unit 110 to irradiate light. More specifically, light irradiated from the light source unit 110 is reflected by the beam splitter 121, and the light reflected by the beam splitter 121 may be reflected by the prism 131 and irradiated to the optical angle controller 130. In addition, the light irradiated to the optical angle controller 130 is irradiated to the outside of the lidar sensor 100 in response to the reflection angle set by the amount of electrical stimulation corresponding to the current applied to the optical angle controller 130.

The processor 140 checks the motion of the lidar sensor 100 measured by the inertial measurement unit 150 at the time when the current is applied to the optical angle controller (130), that is, at the time when the reflection angle θ is set by the applied current.

The motion of the lidar sensor 100 measured by the inertial measurement unit 150 is an inertia value corresponding to the motion generated in the lidar sensor 100, and may include acceleration values, angular velocity values, and geomagnetic field values, etc. of the lidar sensor 100. In the embodiment of the present disclosure, the optical angle controller 130 is described as an example of being included in the lidar sensor 100, but the optical angle controller 130 may be provided in the body (not shown) of the walking robot. In this case, the processor 140 may receive an inertia value corresponding to the motion of the walking robot through communication with the optical angle controller 130.

The processor 140 removes noise with respect to the inertia value by applying a noise reduction filter such as a low-pass filter or the like.

In addition, when a change occurs in the motion of the lidar sensor 100 after the noise for the inertia value is removed, the processor 140 may correct the inertia value using a linear interpolation or quadratic interpolation method. For example, after the processor 140 checks the inertia value corresponding to the reflection angle, if a change in motion is confirmed in the lidar sensor 100, the processor 140 may correct the inertia value corresponding to the motion generated in the lidar sensor 100 by applying the reflection angle and the inertia value corresponding to the reflection angle to a linear interpolation or quadratic interpolation method.

The processor 140 maps the reflection angle and motion, i.e., inertia value, and stores them in the memory 160. In particular, when a change occurs in the reflection angle θ, the processor 140 may store the inertia value according to the reflection angle θ by mapping the inertia value according to the changed reflection angle.

The processor 140 checks whether an object is included in the image data acquired from the image sensor 120. The processor 140 outputs an alarm notifying that an object exists when the image data contains an object.

The processor 140 checks whether the reflection angle needs to be changed. More specifically, if the reflection angle is set to be periodically changed, the processor 140 may confirm that the reflection angle needs to be changed at the time when the change period arrives. In addition, the processor 140 may confirm that the reflection angle needs to be changed by confirming that the condition converges when the object included in the image data exceeds the critical area of the image data.

When it is confirmed that the reflection angle needs to be changed, the processor 140 may control the reflection angle of light irradiated from the optical angle controller 130 by changing the intensity of the current applied to the optical angle controller 130.

The inertial measurement unit 150 is an inertial measurement unit (IMU), and may check inertia values such as acceleration values, angular velocity values, and geomagnetic field values corresponding to motions generated by the lidar sensor 100.

The memory 160 stores at least one instruction capable of controlling the operation of the lidar sensor 100. In addition, it may store the amount of electrical stimulation that can control the reflection angle of light emitted by the optical angle controller 130, that is, the current value for each reflection angle. The memory 160 may store mapping data in which the processor 140 maps inertia values corresponding to motion for each reflection angle.

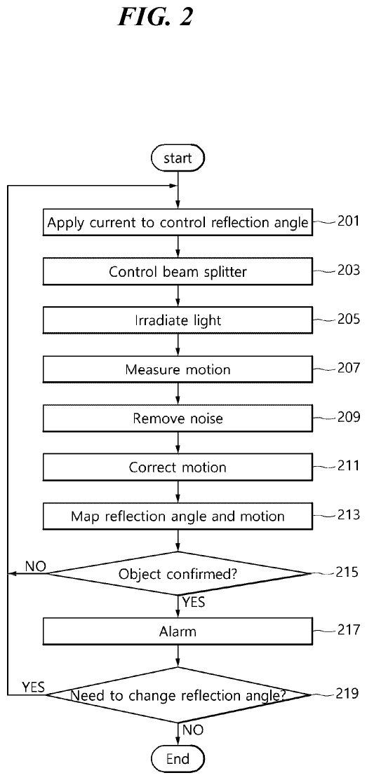

FIG. 2 is a flowchart for describing a method for controlling a lidar sensor mounted on a walking robot according to an exemplary embodiment of the present disclosure.

Referring to FIG. 2, in step 201, the processor 140 applies current to the optical angle controller 130 formed of a metamaterial. In this case, the processor 140 may apply current to the optical angle controller 130 so that the light reflection angle θ may be set by the amount of electrical stimulation in the optical angle controller 130, and light may be irradiated according to the set light reflection angle.

In step 203, the processor 140 controls the angle of the beam splitter 121 included in the image sensor 120. In step 205, the processor 140 controls the light source unit 110 to irradiate light. More specifically, light irradiated from the light source unit 110 is reflected by the beam splitter 121, and the light reflected by the beam splitter 121 may be reflected by the prism 131 and irradiated to a partial area of the optical angle controller 130. In addition, the light irradiated to the partial area of the optical angle controller 130 is irradiated to the outside of the lidar sensor 100 in response to the reflection angle set by the amount of electrical stimulation corresponding to the current applied to the optical angle controller 130.

In step 207, the processor 140 checks the motion of the lidar sensor 100 measured by the inertial measurement unit 150 at the time when the current is applied to set the reflection angle of light in step 201. The motion of the lidar sensor 100 measured by the inertial measurement unit 150 is an inertia value corresponding to the motion generated in the lidar sensor 100, and may include acceleration values, angular velocity values, and geomagnetic field values, etc. of the lidar sensor 100. In step 209, the processor 140 removes noise with respect to the inertia value measured by the inertial measurement unit 150 by applying a noise reduction filter such as a low-pass filter or the like.

In step 211, the processor 140 performs motion correction of the lidar sensor 100 using the inertia value from which the noise is removed. For example, when a change occurs in the motion of the lidar sensor 100 after the noise for the inertia value is removed, the processor 140 may correct the inertia value using a linear interpolation or quadratic interpolation method. For example, after the processor 140 checks the inertia value corresponding to the reflection angle in step 207, if a change in motion is confirmed in the lidar sensor 100, the processor 140 may correct the inertia value corresponding to the motion generated in the lidar sensor 100 by applying the reflection angle set in step 201 and the inertia value confirmed in step 207 to a linear interpolation or quadratic interpolation method. In this case, if there is no change in the motion of the lidar sensor 100, step 211 may be omitted.

In step 213, the processor 140 maps the reflection angle and an inertia value corresponding to motion and stores them in the memory 160. In particular, when a change occurs in the reflection angle, the processor 140 may store the inertia value according to the reflection angle by mapping the inertia value according to the changed reflection angle.

In step 215, the processor 140 checks whether an object is included in the image data acquired from the image sensor 120. As a result of checking in step 215, if the image data includes an object, the processor 140 may proceed to step 217, and if the object is not included, return to step 201 and perform steps 201 to 215 again.

In step 217, the processor 140 outputs an alarm notifying that the object exists and performs step 219. In step 219, if it is confirmed that the reflection angle needs to be changed, the processor 140 may perform step 201, and if it is confirmed that the reflection angle does not need to be changed, the processor 140 may terminate the corresponding process. More specifically, if the reflection angle is set to be periodically changed, the processor 140 may confirm that the reflection angle needs to be changed at the time when the change period arrives. In addition, the processor 140 may confirm that the reflection angle needs to be changed by confirming that the condition converges when the object included in the image data exceeds the critical area of the image data.

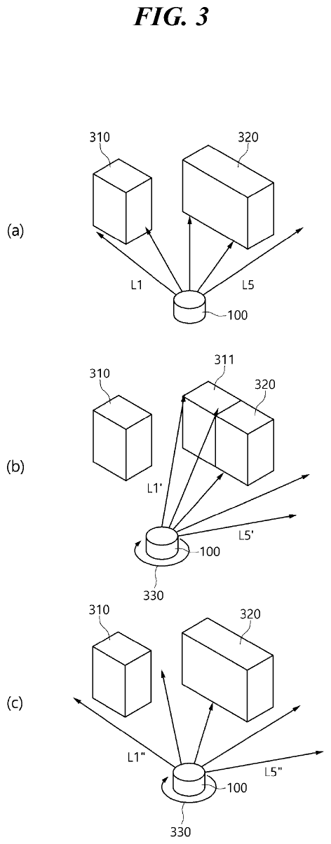

FIG. 3 is a diagram for describing motion compensation of a lidar sensor according to an exemplary embodiment of the present disclosure.

Referring to FIG. 3, FIG. 3(a) shows a first object 310 and a second object 320 existing in the surrounding environment identified by the lidar sensor 100 when motion does not occur in the lidar sensor 100. In this case, L1 to L5 may represent a reflection angle θ at which light is irradiated by the lidar sensor 100 according to the present disclosure, that is, a range of the surrounding environment checked by the lidar sensor 100.

FIG. 3(b) shows a case in which an error occurs in an object existing in the surrounding environment because motion correction is not applied when a motion occurs in the lidar sensor 100. In this case, L1′ to L5′ may represent a range of the surrounding environment checked by the lidar sensor 100. After the lidar sensor 100 checks the first object 310 and the second object 320 as shown in FIG. 3(a), a movement may occur in the direction of the arrows 330 as shown in FIG. 3(b). In this case, if the motion correction of the lidar sensor 100 is not applied, the range of the surrounding environment checked by the lidar sensor 100 may be changed to L1′ to L5′. Therefore, the lidar sensor 100 misrecognizes that the location of the first object 310 checked before the movement occurs exists at the position 311 corresponding to L1′. As such, if the motion correction of the lidar sensor 100 is not applied, there is a problem of misrecognizing the location of the object and the size of the object.

FIG. 3(c) shows a case in which motion correction is applied when a motion is generated in the lidar sensor 100 as in the present disclosure. In this case, L1″ to L5″ may represent a reflection angle θ at which light is irradiated by the lidar sensor 100 according to the present disclosure, that is, a range of the surrounding environment checked by the lidar sensor 100. As shown in FIG. 3(c), when motion correction is applied, the range of the surrounding environment checked by the lidar sensor 100 is expanded as much as the movement occurs in the direction of the arrows 330. Therefore, since the range of the surrounding environment checked by the lidar sensor 100 expands according to the movement of the lidar sensor 100, the locations and sizes of the first object 310 and the second object 320 can be normally recognized.

The embodiments of the present disclosure disclosed in the present specification and drawings are only provided as specific examples to easily describe the technical content of the present disclosure and to aid understanding of the present disclosure, and are not intended to limit the scope of the present disclosure. Therefore, the scope of the present disclosure should be construed that all changes or modifications derived based on the technical idea of the present disclosure in addition to the embodiments disclosed herein are included in the scope of the present disclosure.

1. A lidar sensor mounted on a walking robot, comprising:
a memory containing at least one instruction; and
at least one processor for executing the at least one instruction stored in the memory,
wherein the processor is configured to:
apply current to an optical angle controller formed of a metamaterial to irradiate light according to a reflection angle of light changed by an amount of electrical stimulation, control an inertial measurement unit to measure an inertia value corresponding to a motion of the lidar sensor at the time of irradiating the light, and perform correction of the inertia value.

2. The lidar sensor mounted on a walking robot of claim 1,
wherein the processor is configured to:
check the existence of at least one object based on image data obtained from an image sensor that collects the irradiated light reflected and returned by the at least one object.

3. The lidar sensor mounted on a walking robot of claim 2,
wherein the processor is configured to:
control the angle of a beam splitter included in the image sensor so that light irradiated from a light source unit can be reflected and irradiated by the optical angle controller.

4. The lidar sensor mounted on a walking robot of claim 3,
wherein the processor is configured to:
change the amount of electrical stimulation to selectively change the reflection angle periodically or upon conditional convergence.

5. The lidar sensor mounted on a walking robot of claim 4,
wherein the processor is configured to:
map the reflection angle and the inertia value and store them in the memory.

6. The lidar sensor mounted on a walking robot of claim 5,
wherein the processor is configured to:
correct the inertia value by applying a linear interpolation or quadratic interpolation method when a change in the motion is detected.

7. The lidar sensor mounted on a walking robot of claim 6,
wherein the processor is configured to:
remove noise of the inertia value measured by the inertial measurement unit.

8. The lidar sensor mounted on a walking robot of claim 4,
wherein the processor is configured to:
change the amount of electrical stimulation by confirming that the condition is converged if the at least one object identified in the image data exceeds the critical area of the image data.

9. A lidar sensor mounted on a walking robot, comprising:
a light source unit configured to irradiate light;
an optical angle controller formed of a metamaterial to irradiate light according to a reflection angle of light that is changed by an amount of electrical stimulation;
an inertial measurement unit configured to measure an inertia value corresponding to a motion of the lidar sensor at the time when the optical angle controller irradiates the light; and
a processor configured to apply current corresponding to the amount of electrical stimulation to the optical angle controller and correct the inertia value.

10. The lidar sensor mounted on a walking robot of claim 9, further comprising:
an image sensor comprising a beam splitter that adjusts an angle so that light irradiated from the light source unit can be reflected and irradiated by the optical angle controller, and configured to generate image data by collecting the irradiated light reflected and returned by at least one object.

11. The lidar sensor mounted on a walking robot of claim 10,
wherein the processor is configured to:
change the amount of electrical stimulation periodically or upon conditional convergence so that the reflection angle is selectively changed.

12. The lidar sensor mounted on a walking robot of claim 11,
wherein the processor is configured to:
map the reflection angle and the inertia value.

13. A method for controlling a lidar sensor mounted on a walking robot, comprising:
applying, by a processor, current to an optical angle controller formed of a metamaterial to irradiate light according to a reflection angle of light that is changed by an amount of electrical stimulation;
checking, by the processor, an inertia value corresponding to a motion of the lidar sensor measured by an inertial measurement unit at the time when the optical angle controller irradiates the light; and
correcting, by the processor, the inertia value.

14. The method for controlling a lidar sensor mounted on a walking robot of claim 13, further comprising:
checking, by the processor, the existence of at least one object in image data obtained from an image sensor that collects the irradiated light reflected and returned by the at least one object.

15. The method for controlling a lidar sensor mounted on a walking robot of claim 14,
after the applying current,
further comprising:
controlling, by the processor, the angle of a beam splitter included in the image sensor so that light irradiated from a light source unit can be reflected and irradiated by the optical angle controller; and
controlling, by the processor, the light source unit to irradiate the light.

16. The method for controlling a lidar sensor mounted on a walking robot of claim 15, further comprising:
changing, by the processor, the amount of electrical stimulation to selectively change the reflection angle periodically or upon conditional convergence.

17. The method for controlling a lidar sensor mounted on a walking robot of claim 16,
after the checking an inertia value corresponding to a motion,
further comprising mapping, by the processor, the reflection angle and the confirmed inertia value.

18. The method for controlling a lidar sensor mounted on a walking robot of claim 17,
wherein the correcting is a step of:
correcting the inertia value by applying a linear interpolation or quadratic interpolation method when a change in the motion is detected.

19. The method for controlling a lidar sensor mounted on a walking robot of claim 18, wherein the correcting comprises removing, by the processor, noise of the inertia value.

20. The method for controlling a lidar sensor mounted on a walking robot of claim 16,
wherein the changing the amount of electrical stimulation is a step of:
changing the amount of electrical stimulation by confirming that the condition is converged if the at least one object identified in the image data exceeds the critical area of the image data.
